(19) United States
(12) Patent Application Publication
(10) Pub. No.: US 2004/0179131 A1
(43) Pub. Date: Sep. 16, 2004

(54) Image capturing apparatus and exposure setting method thereof

(75) Inventors: Tsutomu Honda, Osaka (JP); Akira Fukuda, Osaka (JP)

Correspondence Address: McDERMOTT, WILL & EMERY, 600 13th Street, N.W., Washington, DC, 20005, US

(73) Assignee: Minolta Co., Ltd.

(21) Appl. No.: 10/464,448

(22) Filed: Jun. 19, 2003

(30) Foreign Application Priority Data
Mar. 13, 2003 (JP) P2003-068304

(51) Int. Cl. H04N 5/235

(52) U.S. Cl. 348/362

(57) ABSTRACT

A digital camera (image capturing apparatus) includes a liquid crystal display (LCD), a crossed switch constructed by a plurality of buttons, and a turnable dial. The digital camera has a plurality of function modes including an exposure correction mode and a histogram display mode of displaying a finder image and a histogram (luminance distribution) of the finder image on an LCD prior to an image capturing operation. In the exposure correction mode, an exposure correction value is changed by an operation input of two or more steps (actions) of the user on the buttons of the crossed switch. On the other hand, in the histogram display mode, an exposure correction value is changed by an operation input of a single step on the dial. With the configuration, in the case of displaying the luminance distribution regarding a finder image, a simple exposure setting can be made.

This application is based on application No. 2003-068304 filed in Japan, the contents of which are hereby incorporated by reference.

### BACKGROUND OF THE INVENTION

1. Field of the Invention

The present invention relates to a technique of an image capturing apparatus having a plurality of function modes.

2. Description of the Background Art

Some digital cameras (image capturing apparatuses) can display not only a captured image on a display such as an LCD but also various information before an image capturing operation.

For example, Japanese Patent Application Laid-Open Nos. 6-282004 (1994) and 2001-245204 disclose a technique of displaying a finder image which is not yet subjected to image capturing operation (preview image) and, in addition, a luminance distribution of the finder image as a histogram in a real-time manner. It is described that the histogram changes according to exposure conditions.

Although not described in the above publications, even in the case of changing the exposure conditions while recognizing an exposure state by using the histogram, the same operation as a normal exposure condition changing operation is required. The operation is generally a complicated operation of two or more actions, so that it is difficult to easily make exposure setting.

### SUMMARY OF THE INVENTION

The present invention is directed to an image capturing apparatus.

An image capturing apparatus according to the present invention has a plurality of function modes and comprises: (a) an image capturing part for obtaining a preview image of a subject prior to an image capturing operation; (b) a display for displaying the preview image; (c) a mode setting part for setting an image information display mode for displaying information regarding the preview image on the display; (d) a first exposure setting member for making an exposure setting on the basis of a first input operation when a function mode of the image capturing apparatus is set to the image information display mode; and (e) a second exposure setting member for making an exposure setting on the basis of a second input operation when a function mode of the image capturing apparatus is set to a predetermined function mode different from the image information display mode, wherein the number of action(s) of the first input operation by the first exposure setting member is smaller than that of the second input operation by the second exposure setting member. Consequently, at the time of displaying image information of a finder image, a simple exposure setting can be made.

According to a preferred embodiment, in the image capturing apparatus, the first input operation is constructed by a single input action, and the second input operation is constructed by a plurality of input actions. Therefore, a prompt exposure correction can be performed in the image information display mode.

The present invention is also directed to an exposure setting method in an image capturing apparatus having a plurality of function modes.

Therefore, an object of the present invention is to provide a technique of an image capturing apparatus in which a simple exposure setting can be made at the time of displaying image information regarding a finder image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic configuration of the appearance of a digital camera according to a first embodiment of the present invention;

FIG. 2 is a diagram showing a schematic configuration of the appearance of the digital camera of FIG. 1;

FIG. 3 is a diagram showing a schematic configuration of the appearance of the digital camera of FIG. 1;

FIG. 4 is a schematic block diagram showing the internal configuration of the digital camera of FIG. 1;

FIGS. 5A to 5E are diagrams for describing setting of exposure correction values in an exposure correction mode;

FIG. 6 is a flowchart showing basic operation of the digital camera of FIG. 1;

FIG. 7 is a diagram for describing the operation of the digital camera of FIG. 1;

FIG. 8 is a diagram for describing the operation of the digital camera of FIG. 1;

FIG. 9 is a diagram for describing the operation of the digital camera of FIG. 1;

FIG. 10 is a diagram showing a schematic configuration of the appearance of a digital camera according to a second embodiment of the present invention;

FIG. 11 is a diagram showing a schematic configuration of the appearance of the digital camera of FIG. 10;

FIG. 12 is a flowchart showing basic operation of the digital camera of FIG. 10; and

FIG. 13 is a flowchart for describing moving image capturing operation.

### DESCRIPTION OF THE PREFERRED EMBODIMENTS

First Embodiment

Configuration of Main Components of Digital Camera

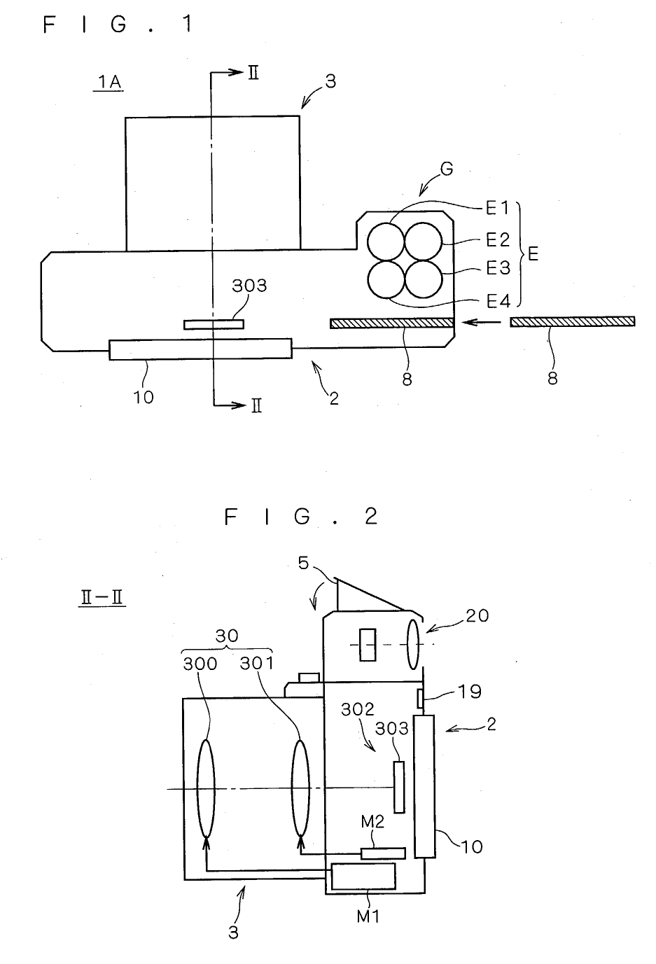

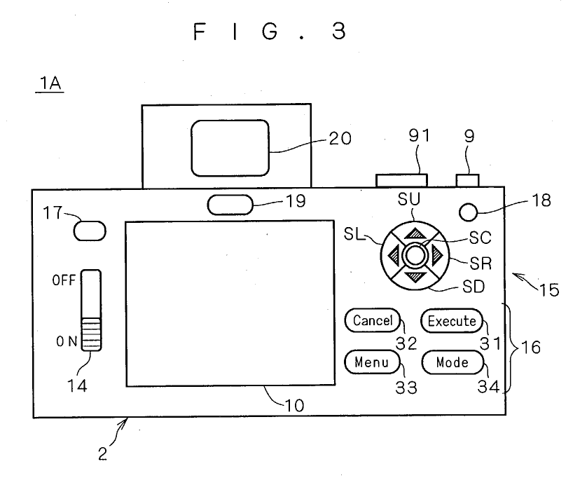

FIGS. 1 to 3 are diagrams each schematically showing the appearance of a digital camera 1A according to a first embodiment of the present invention. FIG. 1 is a plan view of the digital camera 1A. FIG. 2 is a cross section taken along line 11-11 of FIG. 1. FIG. 3 is a rear view of the digital camera 1A.

The digital camera 1A functions as an image capturing apparatus and is constructed by a camera body 2 having an almost rectangular parallelepiped shape and a taking lens 3 which can be detachably attached to the camera body 2. As shown in FIG. 1, a memory card 8 for recording a captured image is removably housed in the digital camera 1A. The digital camera 1A operates on, as a driving source, a power supply battery E in which four AA cells E1 to E4 are connected in series.

As shown in FIG. 2, the taking lens 3 as a zoom lens has a lens unit 30. The diagram shows, as the taking lens 3, two groups of zoom lenses, and the lens unit 30 is roughly divided into two lens units 300 and 301. In FIGS. 2 and 3, for simplicity of the drawings, each of the lens units 300 and 301 is shown as a single lens. In practice, each of the lens units 300 and 301 is not limited to a single lens but may be a group of a plurality of lenses.

The camera body 2 has therein a motor M1 for driving the lens unit 300 and a motor M2 for driving the lens unit 301. By moving the lens units 300 and 301 in the optical axis direction independently at each other by driving the motors M1 and M2, the zoom magnification of the taking lens 3 can be changed. By driving the lens units 300 and 301 by using the motors M1 and M2, the focus state of the taking lens 3 can be changed, that is, focusing (AF) operation can be performed.

A color image capturing device 303 is provided in a proper position rearward of the lens unit 30 of the imaging lens 3. The color image capturing device 303 takes the form of a single-chip color area sensor in which color filters of R (red), G (green) and B (blue) are adhered in a checker pattern on the surface of pixels of the area sensor formed by a CCD. The color image capturing device (hereinafter, referred to as “CCD” (Charged Coupled Device)) 303 has, for example, 1600×1200 pixels. The CCD 303 functions as image capturing means for capturing a finder image (preview image) of a subject before image capturing operation.

As shown in FIG. 1, in the front face of the camera body 2, a grip part G is provided. A pop-up-type built-in flash 5 is provided in a proper position of an upper end of the camera body 2. The built-in flash 5 can emit flat light.

As shown in FIG. 3, a shutter start button 9 and a dial 91 are provided on the top face of the camera body 2. The shutter start button 9 has the function of detecting a lightly depressed state (hereinafter, referred to as “S1 state”) used as a trigger for focus adjustment and a full depression state (hereinafter, referred to as “S2 state”) used as a trigger of capturing an image for recording and determining the state.

The dial 91 is turnable. By turning the dial 91, various setting values can be continuously easily changed. In the case where a histogram display mode (which will be described later) in the plurality of function modes of the digital camera 1A is set, the dial 91 is switched to be used for exposure correction. Specifically, in the histogram display mode, on the basis of an operation input constructed by a single operation input step on the dial 91, exposure setting regarding exposure correction is made. In the case where a function mode other than the histogram display mode is set, a setting of a kind other than the exposure setting is made on the basis of the operation inputted to the dial 91. The settings of other kinds include, for example, adjustment of contrast or saturation and are mainly settings of image capturing conditions other than the exposure adjustment.

On the other hand, on the rear face of the camera body 2, an electronic view finder (hereinafter, referred to as “EVF”) 20 and a liquid crystal display (hereinafter, “LCD”) 10 are provided. Different from an optical finder, the EVF 20 and the LCD 10 for performing live view display of image signals from the CCD 303 in an image capturing standby state function as a finder. A finder image which is not yet subjected to the image capturing operation can be displayed on the EVF 20 and the LCD 10.

The LCD 10 can also display a menu screen for setting image capturing conditions in an image capturing mode and reproduce and display a captured image which is recorded on the memory card 8 in a reproduction mode.

A power switch 14 is provided in the left part of the rear face of the camera body 2 and a crossed switch 15 is provided in the right part of the rear face. The crossed switch 15 has five operation buttons. By depressing buttons SU, SD, SR and SL of four ways of up, down, right and left directions in the operation buttons, various operation can be performed. By depressing an execution button SC, various settings can be determined. The crossed switch 15 functions as, for example, a switch for changing an item selected in the menu screen displayed on the LCD 10 and changing a frame to be reproduced which is selected in an index screen. In the image capturing mode, the right and left buttons SR and SL function as a switch for changing the zoom magnification. Concretely, by changing relative positions of the two lens units 300 and 301 by the driving of the motors M1 and M2, the zoom magnification is changed. More specifically, when the right switch SR is depressed, the lens units 300 and 301 continuously move to the wide angle side. When the left switch SL is depressed, the lens units 300 and 301 continuously move to the telephoto side.

Below the crossed switch 15, a switch group 16 of an execution switch 31, a cancel switch 32, a menu display switch 33 and a mode switch 34 is provided. The execution switch 31 is a switch for determining an item selected on the menu screen. The cancel switch 32 is a switch for canceling an item selected on the menu screen. The menu display switch 33 is a switch for displaying a menu screen on the LCD 10 or switching the item on the menu screen. The mode switch 34 is a switch for switching between an “image capturing mode” and a “reproduction mode” as function modes of the digital camera 1A. The image capturing mode is a mode of capturing a still image or a moving image. The reproduction mode is a mode of reproducing and displaying a captured image recorded on the memory card 8 onto the LCD 10 or EVF 20. When the digital camera 1A is started, the image capturing mode is automatically selected. After the start, each time the mode switch 34 is depressed, the image capturing mode and the reproduction mode are switched.

On the rear face of the camera body 2, a display switch button 17 is provided above the power switch 14, and an AE lock button 18 is provided in the vicinity of the shutter start button 9. The display switch button 17 is a button for switching the function mode to a histogram display mode (luminance distribution display mode) for displaying a histogram indicative of a luminance distribution of image data so as to be superposed on a live view image displayed on the LCD 10 (EVF 20). The AE lock button 18 is a button for locking an AE setting.

In the rear face of the camera body 2, an eye approach sensor 19 is also provided in a center upper portion in the LCD 10. The eye approach sensor 19 senses approach of the user peeping through the EVF 20. When the eye approach sensor 19 senses the approach, the EVF 20 is turned on.

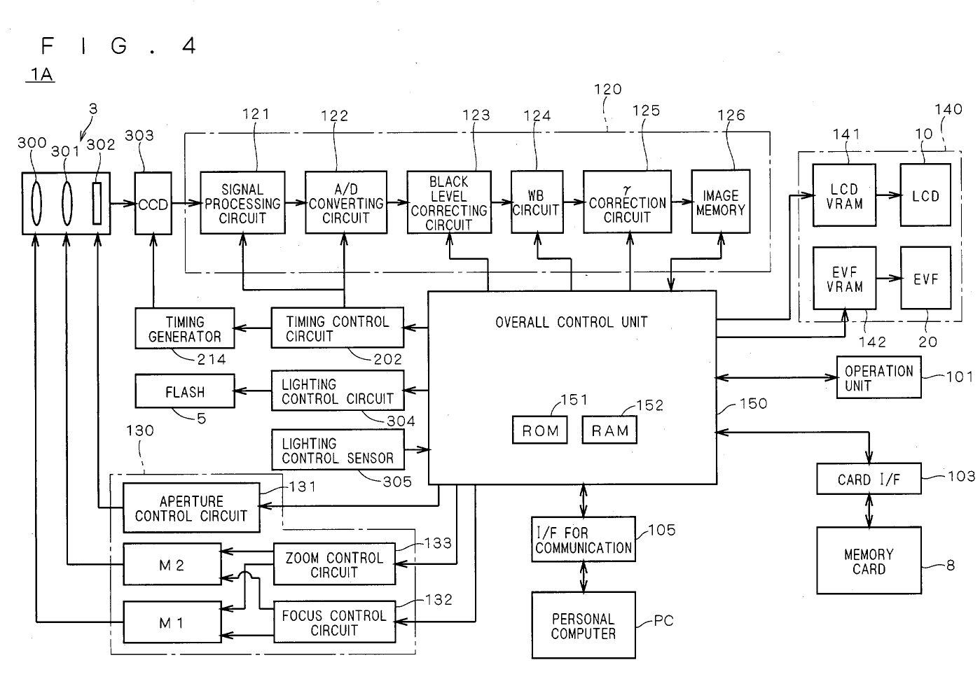

The internal configuration of the digital camera 1A will now be described. FIG. 4 is a schematic block diagram showing the internal configuration of the digital camera 1A.

The taking lens 3 has the lens units 300 and 301 and also an aperture 302 for adjusting the quantity of light passed to the inside. In FIG. 4, for convenience of the diagram, the aperture 302 is disposed on the rear side of the lens unit 301. However, the placement of the aperture 302 is not limited to the above placement. For example, the aperture 302 may be provided in the lens unit 301 (or 300) or provided between the lens units 300 and 301.

A CCD 303 photoelectrically converts a light image of the subject, which is formed by the taking lens 3 into an image signal of color components of R (red), G (green) and B (blue) (signal made by a signal sequence of pixel signals received by each pixel) and outputs the image signal. A timing generator 214 generates various timing pulses for controlling the driving of the CCD 303.

An exposure control in the digital camera 1A is executed by adjusting an exposure amount of the aperture 302 and the CCD 303, that is, charge accumulation time corresponding to shutter speed. In the case where proper shutter speed cannot be set when the luminance of the subject is low, by adjusting the level of an image signal outputted from the CCD 303, improper exposure due to insufficient exposure is corrected. Specifically, at the time of low luminance, the exposure control is executed by a combination of shutter speed and gain adjustment. The level adjustment of an image signal is performed by adjusting the gain of an AGC circuit in a signal processing circuit 121.

The timing generator 214 generates a drive control signal of the CCD 303 synchronously with a reference clock transmitted from a timing control circuit 202. The timing generator 214 generates clock signals such as timing signals indicative of start/end of integration (start/end of exposure) and read control signals (horizontal sync signal, vertical sync signal and transfer signal) of a photosensitive signal of each pixel, and outputs the clock signals to the CCD 303.

A signal processing unit 120 executes predetermined analog signal processing and digital signal processing on the image signal outputted from the CCD 303. The signal processing on the image signal is performed on every photosensitive signal of each of pixels constructing image data. The signal processing unit 120 has the analog signal processing circuit 121, an A/D converting circuit 122, a black level correcting circuit 123, a white balance (WB) circuit 124, a γ correcting circuit 125 and an image memory 126.

The analog signal processing circuit 121 for performing analog signal processing is constructed by mainly a CDS (Correlated Double Sampling) circuit and an AGC (Auto Gain Control) circuit, and performs reduction in sampling noise of a pixel signal outputted from the CCD 303 and adjustment of the signal level. The gain control in the AGC circuit is performed also in the case of compensating an insufficient level of a captured image when proper exposure cannot be obtained from the f-number of the aperture 302 and exposure time of the CCD 303.

The A/D converting circuit 122 converts an image signal as an analog signal outputted from the analog signal processing circuit 121 to image data as a digital signal. The converted image data is temporarily stored in the image memory 126.

The black level correcting circuit 123 corrects the black level of the image signal subjected to A/D conversion in the A/D converting circuit 122 to a reference black level. The WB circuit 124 performs level conversion on image data of each of the color components R, G and B. The WB circuit 124 converts the level of image data of each of the color components R, G and B by using a level conversion table inputted from an overall control unit 150. A conversion coefficient (gradient of a characteristic) of each color component in the level conversion table is set for each captured image by the overall control unit 150.

The γ correcting circuit 125 is a circuit for correcting the γ characteristic of image data and corrects the level of image data by using a preset γ correction table.

The image memory 126 is a memory for temporarily storing image data outputted from the γ correcting circuit 125. The image memory 126 has a storage capacity capable of storing image data of one frame. Specifically, the image memory 126 has a storage capacity of storing image data of 2500×1920 pixels corresponding to the number of pixels of the CCD 303. Each pixel data is stored in a corresponding pixel position.

A lighting control unit 304 controls a light emission quantity of a built-in flash 5 used for photographing with flashlight to a predetermined light emission quantity which is set by the overall control unit 150. At the time of photographing with flashlight, reflection light of flashlight from a subject is received by a lighting control sensor 305 on start of exposure. When a received light amount reaches a predetermined light amount, a light emission stop signal is outputted from the lighting control unit 304. In response to the light emission stop signal, light emission of the built-in flash 5 is forcedly stopped, and the light emission amount of the built-in flash 5 is controlled to a predetermined light emission amount.

A lens control unit 130 controls driving of members of the lens units 300 and 301 and the aperture 302 in the taking lens 3. The lens control unit 130 includes an aperture control circuit 131 for controlling the f-number of the aperture 302, a zoom control circuit 133 for changing the variable power of the zoom by driving the motors M1 and M2, and a focus control circuit 132 for performing focusing control by driving the motors M1 and M2.

The aperture control circuit 131 drives the aperture 302 on the basis of the f-number inputted from the overall control unit 150 and sets the opening amount as the f-number. The focus control circuit 132 controls the drive amount of the motors M1 and M2 on the basis of an AF control signal inputted from the overall control unit 150 to set the lens units 300 and 301 to the focal positions. The zoom control circuit 133 moves the lens units 300 and 301 by driving the motors M1 and M2 on the basis of a zoom control signal inputted from the overall control unit 150 in accordance with an input by the crossed switch 15, thereby moving the zoom to the wide angle side or the telephoto side.

A display unit 140 displays an image on the LCD 10 and the EVF 20. The display unit 140 has, in addition to the LCD 10 and the EVF 20, an LCD VRAM 141 as a buffer memory of image data to be reproduced and displayed on the LCD 10, and an EVF VRAM 142 as a buffer memory of image data reproduced and displayed on the EVF 20. The LCD VRAM 141 has a storage capacity of image data corresponding to the pixel number of 640×480 of the LCD. The EVF VRAM 142 has a storage capacity of image data corresponding to the pixel number of 400×300 of the EVF 20.

In an image capturing standby state, each of pixel data of an image (finder image) sequentially generated every 1/30 (second) by the CCD 303 is subjected to a predetermined signal process by the signal processing unit 120 and, after that, the processed data is temporarily stored in the image memory 126. The data is read by the overall control unit 150 and its data size is adjusted. After that, the resultant data is transferred to the LCD VRAM 141 and the EVF VRAM 142 and displayed as a finder image on the LCD 10 and the EVF 20. Consequently, the user can visually recognize an image of the subject. In a reproduction mode, an image read out from the memory card 8 is subjected to a predetermined signal process by the overall control unit 150 and, after that, the processed data is transferred to the LCD VRAM 141 and reproduced and displayed on the LCD 10.

An operation unit 101 is used to input operation information of operating members related to image capturing and reproduction provided for the camera body 2 to the overall control unit 150. The operation information inputted from the operation unit 101 includes operation information of operating members such as the shutter start button 9, power switch 14, crossed switch 15 and switch group 16.

The overall control unit 150 is a microcomputer for performing centralized control on the image capturing function and the reproducing function. To the overall control unit 150, the memory card 8 is connected via a card interface 103 and a personal computer PC is externally connected via an interface 105 for communication.

The overall control unit 150 has: a ROM 151 in which a processing program for performing a number of concrete processes in the image capturing function and the reproducing function and a control program for controlling driving of the members of the digital camera 1A are stored; and a RAM 152 as a work area for performing a number of computing works in accordance with the processing program and the control program. Program data such as an exposure correction value setting program recorded on the memory card 8 as a recording medium can be read via the card interface 103 and stored into the ROM 151. Therefore, the processing and control programs can be installed from the memory card 8 into the digital camera 1A. Alternately, the processing and control programs may be installed from the personal computer PC via the interface 105 for communication.

The overall control unit 150 has a luminance determining unit and an exposure amount setting unit for setting exposure control values (shutter speed (SS) and an aperture value). In exposure correction, usually, by calling the exposure setting mode as a function mode of the digital camera 1A by using the menu display switch 33 and operating the crossed switch 15, the exposure correction value can be adjusted. A concrete operating method will be described later.

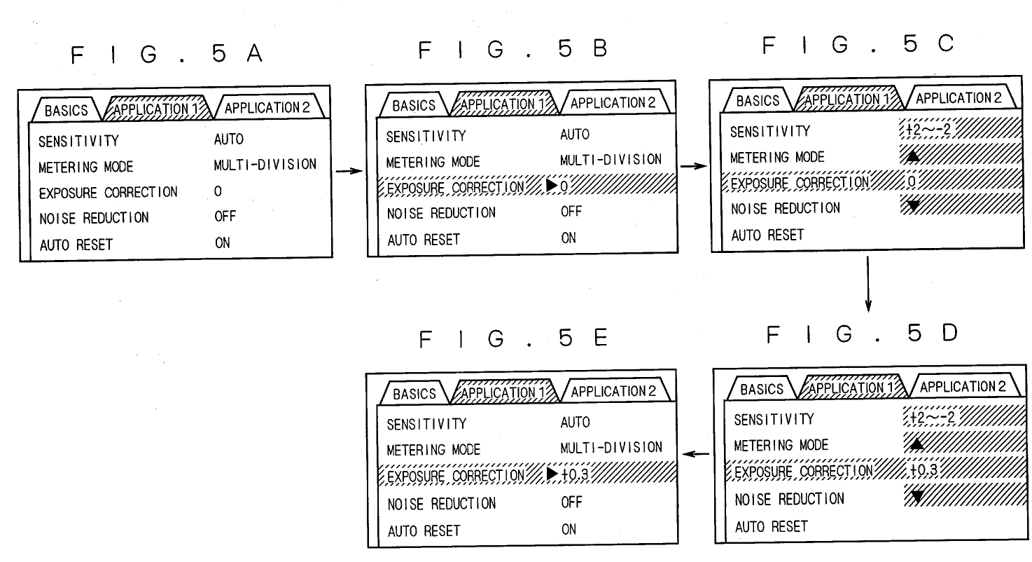

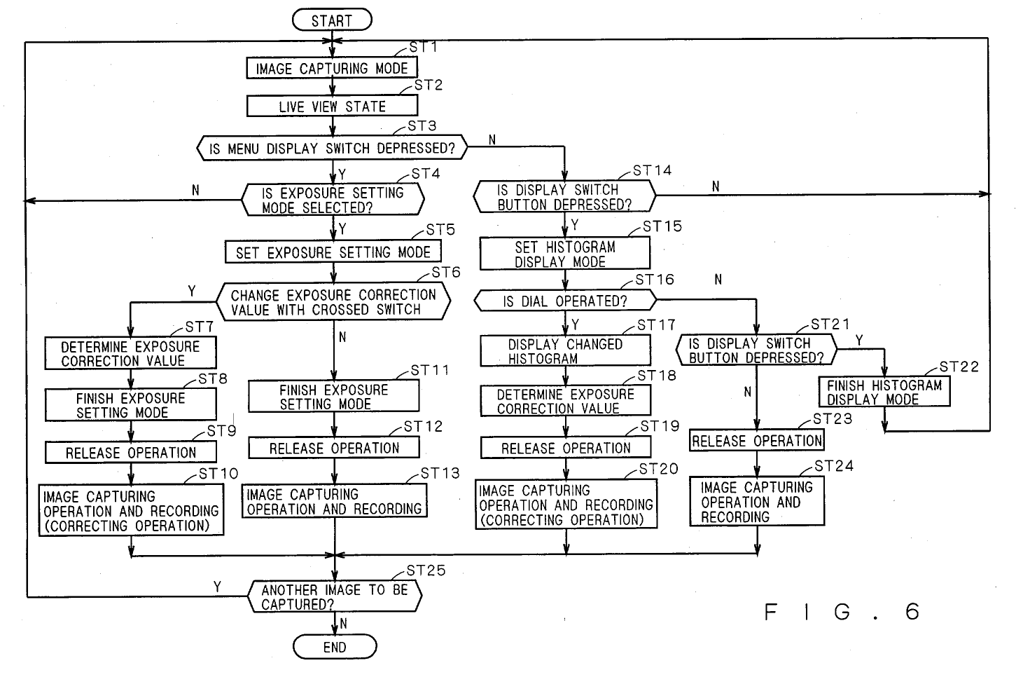

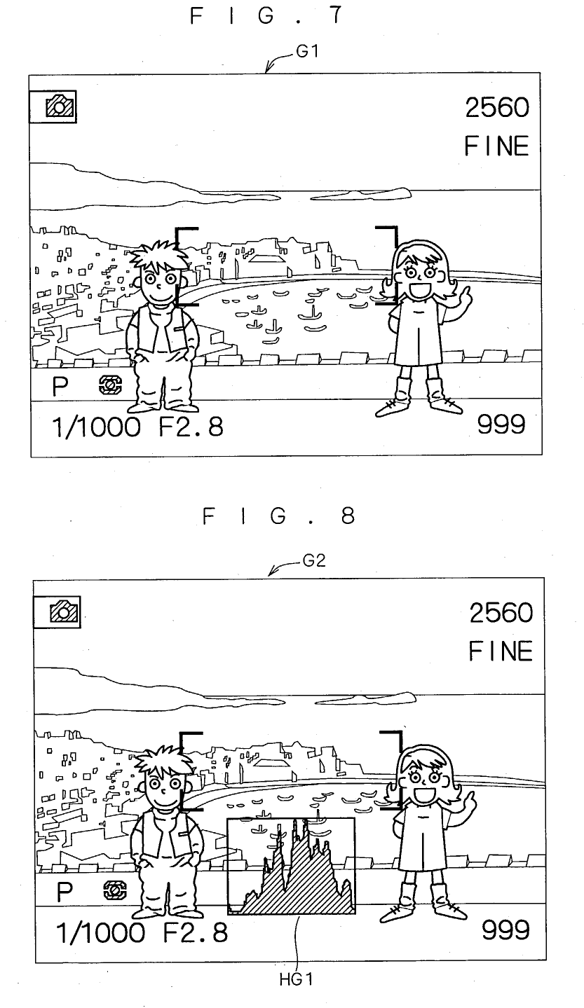

FIGS. 5A to 5E are diagrams for describing setting of an exposure correction value in the exposure setting mode.

First, the user depresses the menu display switch 33, thereby displaying a selection screen shown in FIG. 5A on the LCD 10. Next, by operating the button SU or SD in the crossed switch 15, the exposure setting mode is selected as shown in FIG. 5B. By depressing the execution button SC, the digital camera 1A shifts to the screen shown in FIG. 5C. In the screen, a correction value can be increased/decreased by 0.3 in the range “from +2to −2” each time the button SU or SD is operated. After the correction value is set to a desired correction value as shown in FIG. 5D, the execution button SC is depressed, thereby determining the exposure correction value as “+0.3” (FIG. 5E). When the exposure setting mode is set as described above, exposure setting for the exposure correction is made on the basis of an operation input realized by a plurality of operation input actions with the buttons SU, SD and SC in the crossed switch 15.

For performing a process of recording the captured image, the overall control unit 150 has a filter unit for performing a filtering process and a recording image generating unit for generating a thumbnail image and a compressed image. For reproducing the image recorded on the memory card 8 onto the LCD 10 or EVF 20, the overall control unit 150 has a reproduction image generating unit for generating a reproduction image.

The filter unit corrects high frequency components of an image to be recorded by a digital filter, thereby correcting the picture quality related to a contour. The recording image generating unit reads image data from the image memory 126 and generates a thumbnail image and a compressed image to be recorded on the memory card 8. The recording image generating unit reads pixel data every eight pixels in each of the horizontal and vertical directions from the image memory 126 and sequentially transfers the read pixel data to the memory card 8, thereby recording the thumbnail image onto the memory card 8 while generating the thumbnail image. Further, the recording image generating unit reads all of pixel data from the image memory 126, performs a predetermined compressing process according to the JPEG method such as two-dimensional DCT or Huffman coding on the pixel data to generate image data of a compressed image, and records the compressed image data into an image area in the memory card 8.

In the image capturing mode, when image capturing is instructed by the shutter start button 9, the overall control unit 150 generates a thumbnail image of an image stored into the image memory 126 after the image capturing instruction and an image compressed according to the JPEG method at a set compression ratio and stores both of the images to the memory card 8 together with information such as tag information (frame number, exposure value, shutter speed, compression ratio, date of photographing, data of on/off state of flash at the time of photographing, scene information, an image determination result, and the like) of the captured image.

In each frame in an image recorded on the memory card 8 via the card I/F 103, the tag information, image data of high resolution (1600×1200 pixels) compressed in the JPEG method, and image data (80×60 pixels) for displaying a thumbnail are stored.

When the reproduction mode is selected by the mode switch 34, image data of the largest frame number in the memory card 8 is read and decompressed by the reproduction image generating unit, and the decompressed image is transferred to the LCD VRAM 141 or EVF VRAM 142. Consequently, an image of the largest frame number, that is, the image captured most recently is displayed on the LCD 10 or EVF 20. By operating the button SU, an image of the large frame number is displayed. By operating the button SD, an image of the small frame number is displayed.

Operation of Digital Camera 1A

FIG. 6 is a flowchart for describing basic operation of the digital camera 1A. The operation, particularly, as operation in the image capturing mode, is performed by executing the exposure correction value setting program stored in the ROM 151 in the overall control unit 150.

First, the user turns on the power switch 14 and the image capturing mode is selected by the mode switch 34 (step ST1).

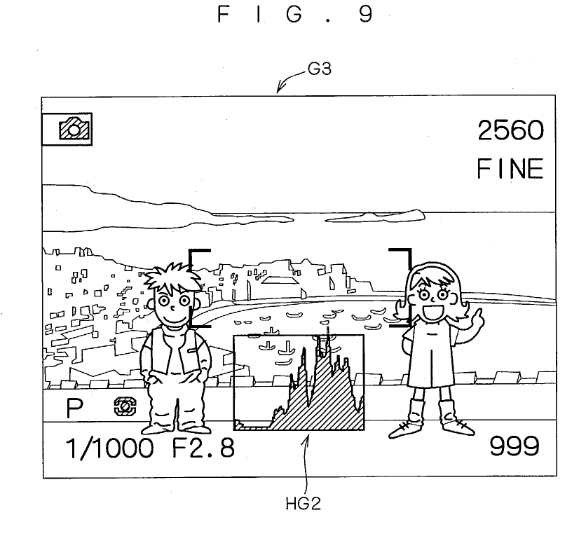

In step ST2, based on image data obtained by the CCD 303, a finder image G1 shown in FIG. 7 is displayed as a live view on the LCD 10. When approach of the user is sensed by the eye approach sensor 19, the LCD 10 is turned off, the EVF 20 is turned on, and the finder image G1 is displayed on the EVF 20. In the following, for convenience of description, the case where approach of the user is not detected, that is, the case where the finder image is displayed on the LCD 10 will be described.

In step ST3, whether the menu display switch 33 is depressed by the user or not is judged. If YES, the selection screen shown in FIG. 5A is displayed on the LCD 10 and the program advances to step ST4. If NO, the program advances to step ST14.

In step ST4, whether the exposure setting mode is selected or not is judged. In this case, as described above, whether or not the exposure setting mode is selected by operating the buttons SU and SD in the crossed switch 15 and the execution button SC is depressed (see FIG. 5B). When the exposure setting mode is selected, the program advances to step ST5 where the exposure setting mode is set. On the other hand, when the exposure setting mode is not selected, the program returns to step ST1.

In step ST6, whether the exposure correction value is changed by the crossed switch 15 or not is judged. In this case, whether or not the exposure correction value “0” shown in FIG. 5C is changed, for example, as shown in FIG. 5D by operating the buttons SU and SD in the crossed switch 15 is decided. In the case where the exposure correction value is changed, the program advances to step ST7. If not, the program advances to step ST11.

In step ST7, the exposure correction value is determined. Concretely, by depressing the execution button SC, the exposure correction value is determined as shown in FIG. 5E.

In step ST8, the exposure setting mode is finished. Concretely, by depression of the menu display switch 33, the exposure setting mode is canceled.

In step ST9, a shutter release operation, that is, an operation of depressing the shutter start button 9 (S2 state) is performed.

In step ST10, image capturing operation is performed and a captured image is recorded. To be specific, image data is captured by the CCD 303 and recorded on the memory card 8. In this case, based on the exposure correction value determined in step ST7, an exposure correcting operation is performed.

In step ST11, in a manner similar to step ST8, the exposure setting mode is finished.

In step ST12, a shutter releasing operation is executed in a manner similar to step ST9.

In step ST13, in a manner similar to step ST10, the image capturing operation is performed and a captured image is recorded. Since the exposure correction value is not changed, different from step ST10, the image capturing operation is performed in a state where the exposure correction value is “0”.

In step ST14, whether the display switch button 17 is depressed by the user or not is judged. If YES, the program advances to step ST15. If NO, the program returns to step ST1.

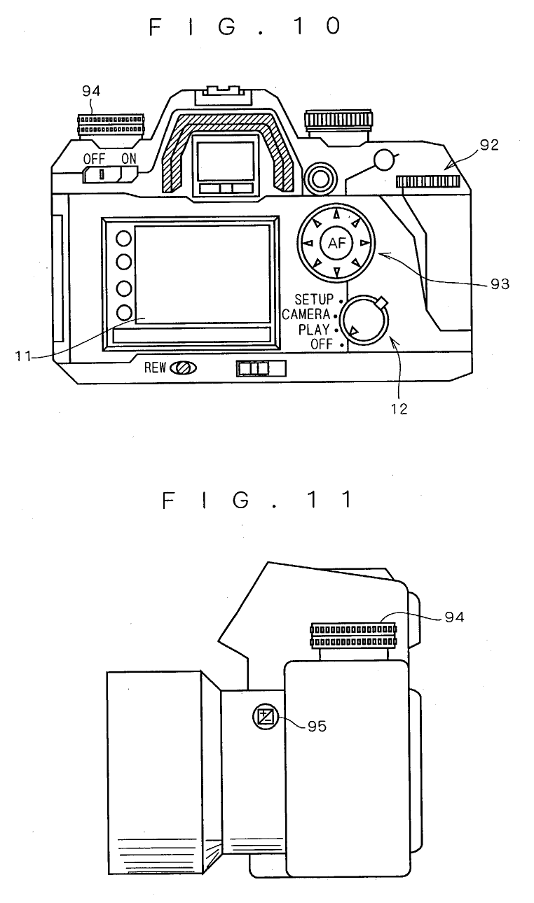

In step ST15, a histogram display mode of displaying a histogram on the LCD 10 is set. Concretely, as shown in FIG. 8, a histogram HG1 (hatched portion) indicative of a luminance distribution of the whole image obtained by the CCD 303 is displayed so as to be superimposed on a finder image G2. By the histogram HGI, the user can grasp average luminance of the finder image G2.

In step ST16, whether the dial 91 is operated by the user or not is judged. If YES, the program advances to step ST17. If NO, the program advances to step ST21.

In step ST17, a changed histogram is displayed. In this case, a histogram is re-generated from a finder image captured under exposure conditions based on the exposure correction value changed by the operation of the dial 91. For example, when the exposure correction value is changed to the “+side” by the operation of the dial 91, a histogram HG2 (hatched portion in FIG. 9) which is shifted to the high luminance side from the histogram HG1 in FIG. 8.

By operating the dial 91 as described above, the exposure correction value can be changed in a manner similar to the exposure setting mode. To be specific, interlockingly with setting of the histogram display mode, a function mode capable of making an exposure setting is set in a manner similar to the exposure setting mode, so that convenience is improved. By the exposure setting made by operating the dial 91, the number of actions of operation input becomes smaller as compared with that of operation input of selecting the exposure setting mode and changing the exposure correction value by the operation of the crossed switch 15 as in steps ST4 to ST6. Thus, the exposure correction value can be changed promptly and accurately.

The reason why the exposure correction value is changed by employing the complicated operation (action) with the buttons SU, SD and SC in the crossed switch 15 in the exposure setting mode is to prevent erroneous operation by certainly making the user aware of a change in the exposure correction value. In contrast, in the histogram display mode, the operation related to the histogram (luminance distribution) is only the exposure correcting operation of changing the luminance condition, so that the user can be clearly aware of it and there is no possibility of an erroneous operation. Therefore, it is arranged so that the exposure correction value can be changed only a simple operation on the dial 91.

In step ST18, the correction value changed by the dial 91 is determined as an exposure correction value.

In step ST19, a shutter release operation is performed in a manner similar to step ST9.

In step ST20, in a manner similar to step ST10, the image capturing operation is performed and a captured image is recorded. In this case, the exposure correcting operation is carried out on the basis of the exposure correction value determined in step ST18.

In step ST21, whether the display switch button 17 is depressed by the user or not is judged. If YES, the program advances to step ST22. If NO, the program advances to step ST23.

In step ST22, the histogram display mode is finished. Specifically, the display of the histogram HGI is erased from the finder image G2 shown in FIG. 8.

In step ST23, a shutter releasing operation is performed in a manner similar to step ST9.

In step ST24, in a manner similar to step ST13, the image capturing operation is performed and a captured image is recorded.

In step ST25, whether the user captures another image or not is judged. In this case, whether a mode other than the image capturing mode is selected by the mode switch 34 or not is decided. If a mode other than the image capturing mode is selected, the operation in the image capturing mode is finished. On the other hand, when the user takes another image, the program returns to step ST1.

By the above-described operation of the digital camera 1A, the exposure correction value is changed only by the operation of the dial 91 in the histogram display mode. Consequently, in the case of displaying a luminance distribution regarding a finder image, a simple and prompt exposure setting can be made. On the other hand, in the exposure setting mode, the exposure setting is made by an operation which is more complicated as compared with the exposure setting in the histogram display mode. Thus, the user is certainly made aware of the fact that the operation is regarding the exposure setting, so that erroneous operation can be prevented.

At the time of photographing with flash of the built-in flash 5 in the digital camera 1A, in the case where the histogram display mode is selected, the user lightly presses the shutter start button 9 (or depresses the AE lock button 18), thereby allowing the built-in flash 5 to make pre-emission, and a finder image and a histogram may be displayed on the LCD 10. In this case, it is not indispensable to obtain image data of total pixel number of 2500×1920 of the CCD 303 as image data but image data obtained by reducing the pixels to the number corresponding to the display pixel number of the LCD 10 may be obtained. The user operates the dial 91 in consideration of a histogram displayed and performs image capturing with flashlight.

In the case of using a CCD in which pixels can be combined, the light amount in the pre-emission operation can be decreased according to a pixel addition amount. Concretely, in the case of combining neighboring two pixels, the light amount which is about the half of the light amount in the case where the pixels are not combined is sufficient. Therefore, charge-up time of the built-in flash 5 is shortened so that promptly photographing with flashlight can be realized. A chance to take a good picture can be prevented from being missed. Alternately, by increasing the gain of the AGC circuit in the signal processing circuit 121, the quantity of pre-emission can be suppressed.

Second Embodiment

Main Components of Digital Camera

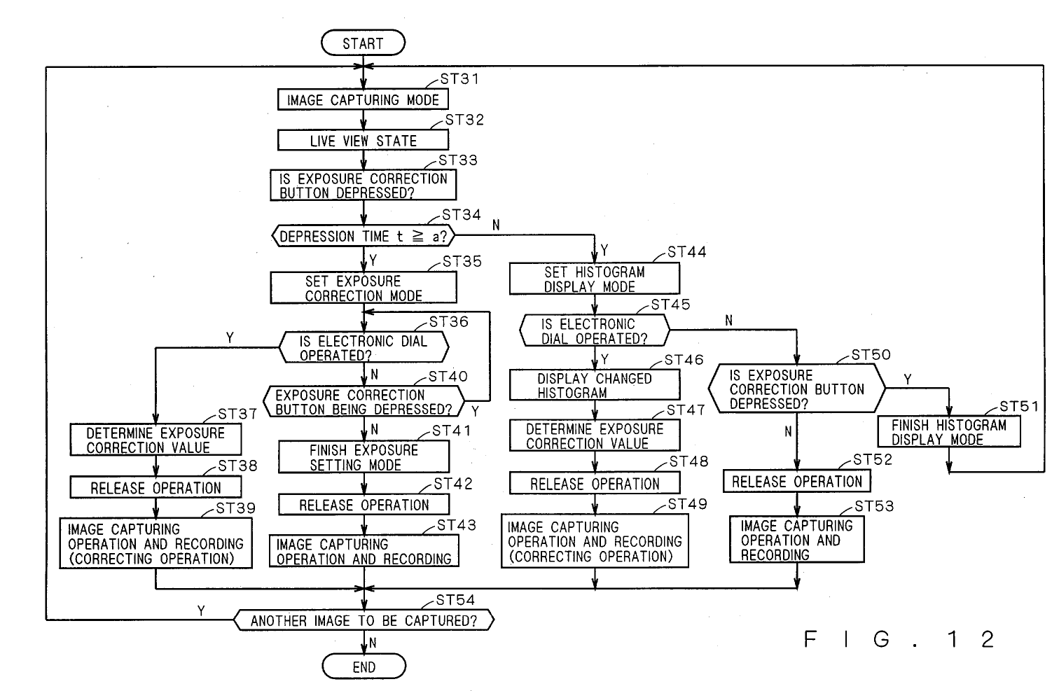

FIGS. 10 and 11 are diagrams each schematically showing the appearance of a digital camera 1B according to a second embodiment of the present invention. FIG. 10 is a rear view of the digital camera 1B. FIG. 11 is a side view of the digital camera 1B seen from the left side of FIG. 10.

In the rear face of the digital camera 1B, a liquid crystal display (LCD) 11 similar to that in the digital camera 1A, a mode dial 12, an electronic dial 92, and a point selection dial 93 are provided. On the top face of the digital camera 1B, a sensitivity setting dial 94 for setting sensitivity is provided.

The mode dial 12 functions as a main switch for turning on/off the power source and also functions as a switch for switching between the image capturing mode (CAMERA mode) and a reproduction mode (PLAY mode) in a manner similar to the digital camera 1A.

In the camera lens barrel of the digital camera 1B, an exposure correction button 95 is provided. According to an operation inputted to the exposure correction button 95 (one operation member), either the exposure correction mode or the histogram display mode can be set (which will be described in detail later). With the configuration, an increase in the number of operation members can be suppressed. In addition, since operation inputs regarding the exposure correction mode and the histogram display mode which are related to each other are assigned to the exposure correction button 95, so that the user can easily understand the operation inputs through intuition and operability is improved.

Further, in the exposure correction mode and the histogram display mode, the exposure correction value can be changed by operation including operation inputs to the electronic dial 92, that is, the same operation member (detailed description will be given later). It makes intuitive understanding of the user regarding the operation inputs easier, so that operability is further improved.

The internal configuration of the digital camera 1B is similar to that in the first embodiment shown in FIG. 4. By executing the exposure correction value setting program in the overall control unit 150, the operation of the digital camera 1B described later is executed.

Operation of Digital Camera 1B

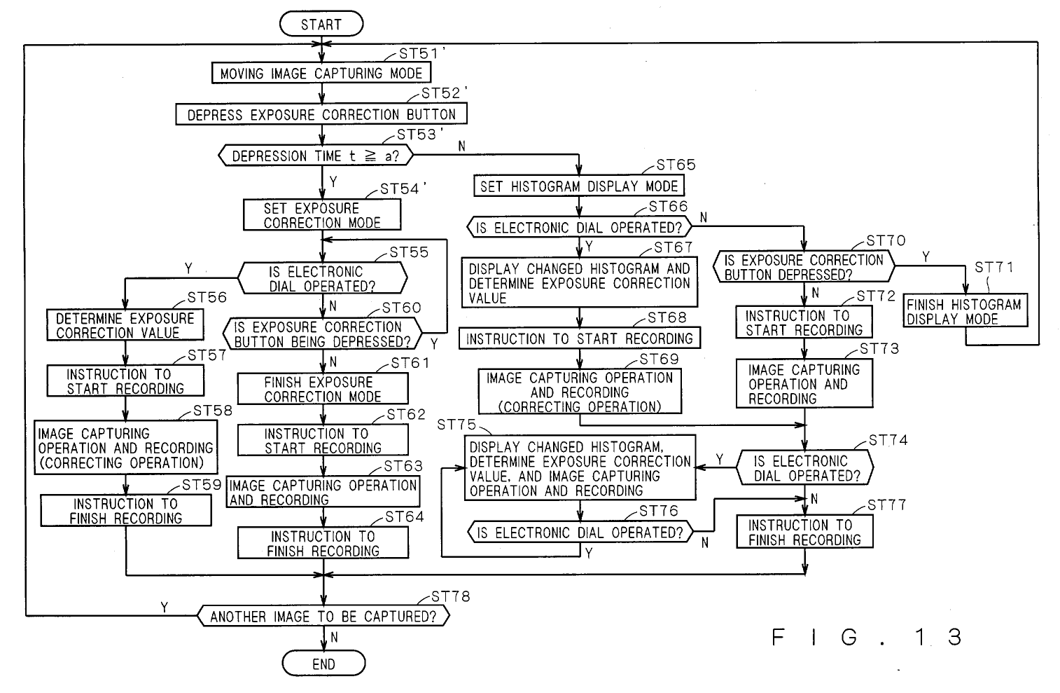

FIG. 12 is a flowchart for describing basic operation of the digital camera 1B.

In steps ST31 and ST32, operations similar to those in steps ST1 and ST2 in FIG. 6 are performed.

In step ST33, the exposure correction button 95 is depressed by the user.

In step ST34, depression time on the exposure correction button 95 is detected and whether the depression time “t” becomes equal to or longer than predetermined time “a” (for example, two seconds) is judged. If YES, the program advances to step ST35 and the exposure correction mode is set. On the other hand, when the depression time “t” is shorter than the predetermined time “a”, the program advances to step ST44. By the operation in step ST34, the setting is selectively switched between the setting to the histogram display mode and the setting to the exposure correction mode in accordance with operation time of the exposure correction button 95.

In step ST36, whether the electronic dial 92 is operated by the user or not is judged. If YES, the program advances to step ST37. If NO, the program advances to step ST40.

In step ST37, a correction value changed by the electronic dial 92 is determined as an exposure correction value.

In steps ST38 and ST39, operations similar to those in steps ST9 and ST10 shown in FIG. 6 are performed.

In step ST40, whether or not the exposure correction button 95 has been continuously depressed since the depression started in step ST33 is judged. In the case where the exposure correction button 95 is being depressed, the program returns to step ST36. If the exposure correction button 95 is not depressed, the program advances to step ST41.

In steps ST41 to ST43, operations similar to those in steps ST11 to ST13 shown in FIG. 6 are performed.

In step ST44, the histogram display mode for displaying a histogram on the LCD 11 is set. Concretely, as shown in FIG. 8, the histogram HGI (hatched portion) indicative of the luminance distribution of the whole image is displayed so as to be superimposed on the finder image G2.

In step ST45, whether the electronic dial 92 is operated by the user or not is judged. If YES, the program advances to step ST46. If NO, the program advances to step ST50.

In step ST46, a changed histogram is displayed. For example, when the exposure correction value is changed to the “+side” by the operation of the electronic dial 92, the histogram HG2 (hatched portion in FIG. 9) shifted to a higher luminance side as compared with the histogram HG1 of FIG. 8 is graphically displayed. In the histogram display mode, the exposure correction value is changed by the operation input of one action only to the electronic dial 92. Consequently, the number of actions of the operation input is smaller than that of the operation input of two actions constructed by the depression of the exposure correction button 95 (step ST40) and the operation of the electronic dial 92 (step ST36) as in the exposure correction mode. As a result, the exposure correction value can be changed promptly and accurately.

The reason why the exposure correction value is changed by employing the complicated operation of operating the electronic dial 92 while depressing the exposure correction button 95 in the exposure correction mode is to prevent erroneous operation by certainly making the user aware of a change in the exposure correction value. In contrast, in the histogram display mode, the operation related to the histogram (luminance distribution) is only the exposure correcting operation of changing the luminance condition, so that the user can be clearly aware of it and there is no possibility of an erroneous operation. Therefore, it is arranged so that the exposure correction value can be changed only a simple operation on the electronic dial 92.

In step ST47, the correction value changed by the electronic dial 92 is determined as an exposure correction value.

In steps ST48 and ST49, operations similar to those in steps ST19 and ST20 shown in FIG. 6 are performed.

In step ST50, whether the exposure correction button 95 is depressed by the user or not is judged. If YES, the program advances to step ST51. If NO, the program advances to step ST52.

In step ST51, in a manner similar to step ST22 shown in FIG. 6, the histogram display mode is finished.

In steps ST52 and ST53, operations similar to those in steps ST23 and ST24 shown in FIG. 6 are performed.

In step ST54, whether the user takes another photograph or not is judged. In this case, whether a mode other than the image capturing mode is selected by the mode dial 12 or not is decided. If a mode other than the image capturing mode is selected, the operation in the image capturing mode is finished. On the other hand, when the user takes another image, the program returns to step ST31.

By the above-described operation of the digital camera 1B, the exposure correction value is changed only by the operation of the electronic dial 92 in the histogram display mode. Consequently, in the case of displaying a luminance distribution regarding a finder image, a simple exposure setting can be made. On the other hand, in the exposure correction mode, the exposure setting is made by an operation which is more complicated as compared with the exposure setting in the histogram display mode. Thus, the user is certainly made aware of the fact that the operation is regarding the exposure setting, so that erroneous operation can be prevented.

In the case where the digital camera 1B has a moving image capturing mode capable of capturing a moving image, the exposure setting method may be applied to the moving image capturing. In the following, the operation regarding the moving image capturing will be described.

FIG. 13 is a flowchart for describing the operation of the moving image capturing.

In step ST51′, the moving image capturing mode is set by the user.

In steps ST52′, ST53′, ST54′, ST55 and ST56, operations similar to those in steps ST33 to ST37 in FIG. 12 are performed.

In step ST57, it is instructed by the user to start recording a moving image.

In step ST58, the moving image capturing operation is performed and a moving image captured is recorded. In this case, on the basis of the exposure correction value determined in step ST56, the exposure correcting operation is performed.

In step ST59, the user instructs to finish the recording of a moving image.

In steps ST60 and ST61, operations similar to those in steps ST40 and ST41 in FIG. 12 are performed.

In step ST62, in a manner similar to step ST57, it is instructed to start recording a moving image.

In step ST63, in a manner similar to step ST58, the moving image capturing operation is performed and a captured moving image is recorded. Although the exposure correction value is not changed, different from step ST58, the image capturing operation is performed in a state where the exposure correction value is “0”.

In step ST64, in a manner similar to step ST59, it is instructed to finish the moving image recording.

In steps ST65 and ST66, operations similar to those in steps ST44 and ST45 in FIG. 12 are performed.

In step ST67, operations similar to steps ST46 and ST47 in FIG. 12 are performed.

In steps ST68 and ST69, operations similar to those in steps ST57 and ST58 are performed.

In steps ST70 and ST71, operations similar to those in steps ST50 and ST51 in FIG. 12 are performed.

In steps ST72 and ST73, operations similar to those in steps ST62 and step ST63 are performed.

In step ST74, an operation similar to that in step ST66 is performed. Specifically, when the electronic dial 92 is operated also during capture of a moving image, the program advances to step ST75 where the histogram is changed and displayed. Consequently, the user can sequentially execute exposure correction by operating the electronic dial 92 while recognizing the histogram during photographing.

In step ST75, operations similar to those in steps ST67 and ST69 are performed.

In step ST76, an operation similar to that in step ST74 is performed.

In step ST77, in a manner similar to step ST59, end of recording is instructed.

In step ST78, an operation similar to that in step ST54 in FIG. 12 is carried out.

By the above-described operation of the moving image capturing mode, the exposure correction value is changed only by the operation of the electronic dial 92 in the histogram display mode also during capture of a moving image. Consequently, in the case of displaying a luminance distribution regarding a captured image, a simple and prompt exposure setting can be made. On the other hand, in the exposure correction mode, the exposure setting is made by an operation which is more complicated as compared with the exposure setting in the histogram display mode. Thus, the user is certainly made aware of the fact that the operation is regarding the exposure setting, so that erroneous operation can be prevented.

Modifications

In each of the foregoing embodiments, it is not indispensable to perform the exposure control by adjustment of charge accumulation time by the CCD. The exposure control can be also performed by additionally providing a mechanical shutter and adjusting exposure time with the mechanical shutter.

In each of the foregoing embodiments, a luminance distribution is obtained from pixel information of all of red (R), green (G) and blue (B) in image data and expressed as a histogram or the like. However, the present invention is not limited thereto. Alternately, density information based on pixel values of one color selected from R, G and B, that is, regarding one wavelength range of light may be displayed. Concretely, a component distribution (density distribution) of a wavelength range is displayed. In this case, for example, a menu screen is displayed by operating the menu display switch, and a specific wavelength range in the menu screen is designated. By such density information display, a more-detailed density distribution can be grasped.

In each of the foregoing embodiments, it is not indispensable to display the luminance distribution by a histogram. The luminance distribution may be displayed by a display form such as a line graph.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus having a plurality of function modes, comprising:
(a) an image capturing part for obtaining a preview image of a subject prior to an image capturing operation;
(b) a display for displaying said preview image;
(c) a mode setting part for setting an image information display mode for displaying information regarding said preview image on said display;
(d) a first exposure setting member for making an exposure setting on the basis of a first input operation when a function mode of said image capturing apparatus is set to said image information display mode; and
(e) a second exposure setting member for making an exposure setting on the basis of a second input operation when a function mode of said image capturing apparatus is set to a predetermined function mode different from said image information display mode, wherein
the number of action(s) of said first input operation by said first exposure setting member is smaller than that of said second input operation by said second exposure setting member.

2. The image capturing apparatus according to claim 1, wherein
said first input operation is constructed by a single input action, and said second input operation is constructed by a plurality of input actions.

3. The image capturing apparatus according to claim 1, wherein
said mode setting part sets an exposure correction mode interlockingly with setting of said image information display mode.

4. The image capturing apparatus according to claim 1, wherein
said second exposure setting member has an operation member for setting an exposure correction mode, and
said mode setting part sets said image information display mode in response to an input operation on said operation member.

5. The image capturing apparatus according to claim 4, further comprising:
(f) an operation time detector for detecting operation time on said operation member, wherein
said mode setting part switches between said image information display mode and said exposure correction mode in accordance with said operation time detected by said operation time detector.

6. The image capturing apparatus according to claim 4, wherein
said first input operation and said second input operation include an input action to a same operation member.

7. The image capturing apparatus according to claim 1, wherein
luminance information of said preview image is displayed in said image information display mode.

8. The image capturing apparatus according to claim 1, wherein
density information of said preview image is displayed in said image information display mode.

9. An exposure setting method in an image capturing apparatus having a plurality of function modes, comprising the steps of:
(a) obtaining a preview image of a subject prior to an image capturing operation;
(b) displaying said preview image on a display;
(c) setting an image information display mode for displaying information regarding said preview image on said display;
(d) making an exposure setting on the basis of a first input operation when a function mode of said image capturing apparatus is set to said image information display mode; and
(e) making an exposure setting on the basis of a second input operation when a function mode of said image capturing apparatus is set to a predetermined function mode different from said image information display mode, wherein
the number of action(s) of said first input operation by said first exposure setting member is smaller than that of said second input operation by said second exposure setting member.

10. The exposure setting method according to claim 9, wherein
said first input operation is constructed by a single input action, and said second input operation is constructed by a plurality of input actions.

11. The exposure setting method according to claim 9, further comprising the step of:
(f) setting an exposure correction mode interlockingly with setting of said image information display mode.

12. The exposure setting method according to claim 9, wherein
said second input operation includes an input action performed by an operation member for setting an exposure correction mode, and
said image information display mode is set in response to an input operation on said operation member.

13. The exposure setting method according to claim 12, further comprising the steps of:
(g) detecting operation time on said operation member; and
(h) making a switching between said image information display mode and said exposure correction mode in accordance with said operation time detected in said step (g).

14. The exposure setting method according to claim 12, wherein
said first input operation and said second input operation include an input action to a same operation member.

15. An image capturing apparatus comprising:
(a) an image capturing part for obtaining a preview image of a subject prior to an image capturing operation in a moving image capturing mode;
(b) a display for displaying said preview image; and
(c) a controller for displaying image information regarding said preview image onto said display.

16. The image capturing apparatus according to claim 15, wherein
said image information includes luminance information of said preview image.

17. The image capturing apparatus according to claim 15, wherein
said image information includes density information of said preview image.

18. The image capturing apparatus according to claim 15, further comprising:
(d) an exposure setting member for making an exposure setting on the basis of said image information displayed on said display.

19. The image capturing apparatus according to claim 18, wherein
an exposure setting is made by said exposure setting member, a moving image is captured and recorded and, after that, said image information changed by said exposure setting is displayed on said display.
